(19) United States
(12) Patent Application Publication
(10) Pub. No.: US 2003/0062324 A1
(43) Pub. Date: Apr. 3, 2003

(54) Oil - water separator

(75) Inventors: Steven M. Abrams, New Albany, OH (US); Jimmy D. Schroeder, Hastings, MN (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Steel Tank Institute, Lake Zurich, IL (US)

(21) Appl. No.: 10/211,968

(22) Filed: Aug. 2, 2002

Related U.S. Application Data
(60) Provisional application No. 60/310,023, filed on Aug. 3, 2001.

(51) Int. Cl. B01D 17/00

(52) U.S. Cl. 210/800; 210/519; 210/DIG. 5

(57) ABSTRACT

The oil-water separator includes a tank defining an enclosed volume. The oil and water mixture is introduced into the enclosed volume by a length of coalescing pipe that causes the oil to coalesce together and separate from the water. In the enclosed volume, the oil floats on top of the water. To discharge the water from the enclosed volume while retaining the oil, an outlet is provided in a lower region of the enclosed volume that the oil cannot access.

### CROSS-REFERENCE TO RELATED APPLICATIONS

This application claims the benefit of U.S. Provisional Application 60/310,023 filed on Aug. 3, 2001.

### FIELD OF THE INVENTION

This invention relates generally to separating oil from water, and more particularly to methods and devices for separating and removing oil from water.

### BACKGROUND OF THE INVENTION

One cause of oil being mixed with water is when water comes into contact with man-made facilities. For instance, rain falling on a paved parking lot often becomes mixed with oil that has leaked onto the surface of the lot from vehicles parked thereon. This oil becomes mixed with and carried off by the runoff water.

Federal, state and local laws may exist that regulate how and when facilities should treat the runoff. For example, an industrial user who controls or collects storm water and discharges it through a pipe, drain or other outlet, into a sewer system or navigable waterway must comply with the National Pollutant Discharge Elimination System (NPDES). Mandated by Congress under Section 402 of the Clean Water Act, the NPDES storm water program is a two-phased approach to eliminating or reducing accidental and chronic low-level releases of oil-polluted water. A working oil water separator is an important part of a storm water drainage system designed for facility compliance with the NPDES storm water program.

To meet water runoff compliance regulations, the storm water drainage systems must be capable of removing the petroleum hydrocarbons from the natural water runoff at least down to 15 parts per million (ppm), which includes the removal of all free oil droplets equal to or greater than 20 microns in size. One standard for testing the performance of an oil water separator is UL Subject 2215 Outline of Investigation for Oil/Water Separator which is incorporated herein by reference.

To comply with these laws and to protect the environment, many processes and devices have been developed to remove the intermixed oil from the runoff before it is discharged. Such processes and devices are typically used in parking garages, military installations, process plants, maintenance facilities and service stations that process storm water runoff or process water.

Examples of these processes and devices include chemical treatment of the runoff and complex filtering machines through which the runoff is passed. However, these processes and devices are often complicated in operation and costly to employ. For instance, chemical treatments must repeatedly be administered and may require specially trained operators and safety protections. Complicated filter machines typically require high initial costs to purchase and install, and often utilize numerous parts and special equipment that can become damaged and necessitate replacement.

Thus, there exists a need for an inexpensive device or process that can efficiently separate oil from contaminated water. There also exists a need for a device or process that separates oil from water that is uncomplicated and not susceptible to equipment breakdown. There further exists a need for an oil separator that can be easily constructed from readily available parts.

### SUMMARY OF THE PRESENT INVENTION

The present invention overcomes the deficiencies of the prior art by providing a low cost device and simplified method for separating oil and water that have been mixed together. The oil-water separator operates on the principles that non-emulsified oil suspended in water will tend to coalesce together thereby separating from the water and, due to the dissimilar specific gravities, floats on top of the water.

Specifically, the oil-water separator includes a tank having an inlet and a length of coalescing pipe in communication with the inlet. For separating the oil from the water, the entering mixture passes through the pipe which slows the velocity of the mixture allowing the intermixed oil to coalesce together. The pipe discharges into an enclosed volume defined by the tank and where the separated oil, because of its lighter specific gravity, floats on top of the heavier water. To permit water to exit the tank while retaining the oil therein, a water outlet pipe is disposed through the tank near the bottom where it is inaccessible to the floating oil.

In an embodiment of the present invention, a plurality of pipes communicate with the inlet such that the inflowing mixture encounters multiple channels, any of which the mixture can pass through to the tank. Presenting the mixture with a plurality of channels effectively increases the coalescing surface area of the pipe against which the oil can begin to coalesce. In another embodiment, for imparting a centrifugal force upon the mixture to aid in separation of oil from water, the coalescing pipe is configured into a coiled helix.

As the separated oil accumulates inside the tank, it will eventually become necessary to remove the oil. For accomplishing this, a separate outlet is disposed through the tank and configured to access the floating oil. The oil can then be pumped out of the tank through this outlet. Preferably, an oil level float switch or sight glass is provided to permit monitoring of the accumulated oil.

An advantage of the present invention is it provides a low cost and efficient way to separate oil from an oil-water mixture that takes advantage of the inherent physical properties of oil and water. Another advantage is its uncomplicated design and its simplicity of operation that results in its resistance to breaking down and corresponding long life. Another advantage is its use of bulk or readily available materials and its low cost of construction. Yet another advantage of the present invention is that it provides for immediate discharge of separated water while retaining oil for later disposal. These and other advantages and features of the present invention will be apparent from the detailed description and accompanying drawings.

### BRIEF DESCRIPTION OF THE DRAWINGS

FIG. 1 is a cross-sectional view of an exemplary oil-water separator illustrated in a typical setting.

FIG. 2 is a cut away side view of an embodiment of the oil-water separator shown in FIG. 1 illustrating the arrangement of the inlet, oil pump out fitting, water outlet pipe, and oil level float switch within the tank.

FIG. 3 is a cross-sectional view taken along lines III-III of FIG. 2.

FIG. 4 is a cross-sectional view taken along lines IV-IV of FIG. 2.

FIG. 5A is an end view of a corrugated pipe.

FIG. 5B is a side view of the corrugated pipe shown in FIG. 5A.

FIG. 6A is an end view of a smooth pipe.

FIG. 6B is a cross-sectional view of the pipe shown in FIG. 6A at line B-B.

FIG. 7 is a cut away side view of another embodiment of the oil-water separator shown in FIG. 1 illustrating a single length of coalescing pipe.

FIG. 8 is a cut away side view of another embodiment of the oil-water separator shown in FIG. 1 illustrating a helically coiled coalescing pipe in a cylindrical tank.

FIG. 9 is a cross-sectional view taken along lines IX-IX of FIG. 8.

FIG. 10 is a cross-sectional view taken along lines X-X of FIG. 8.

FIG. 11 is a cut away side view of another embodiment of the oil-water separator shown in FIG. 1 illustrating a helically coiled coalescing pipe in a rectangular tank.

FIG. 12 is a cross-sectional view taken along lines XII-XII of FIG. 11.

FIG. 13 is a cut away side view of another embodiment of the oil-water separator shown in FIG. 1 illustrating two helically coiled coalescing pipes configured for multiple stage separation.

FIG. 14 is a cross-sectional view taken along lines XIV-XIV of FIG. 13.

FIG. 15 is a cut away side view of another embodiment of the oil-water separator shown in FIG. 1 illustrating two helically coiled coalescing pipes communicating with the inlet.

FIG. 16 is a cross-sectional view taken along lines XVI-XVI of FIG. 15.

FIG. 17 is a cut away side view of another embodiment of the oil-water separator shown in FIG. 1 illustrating multiple helically coiled coalescing pipes communicating with the inlet through the manifold box.

FIG. 18 is a cross-sectional view taken along lines XVIII-XVIII of FIG. 17.

FIG. 19 is a cut away side view of another embodiment of the oil-water separator shown in FIG. 1 illustrating additional coalescing media.

FIG. 20 is a cut away side view of another embodiment of the oil-water separator shown in FIG. 1 illustrating multiple additional coalescing media.

FIG. 21 is a cut away side view of another embodiment of the oil-water separator shown in FIG. 1 illustrating a manway configured to function as a manifold box.

FIG. 22 is a chart of exemplary values for oil-separator tanks of various sizes.

### DETAILED DESCRIPTION OF THE INVENTION

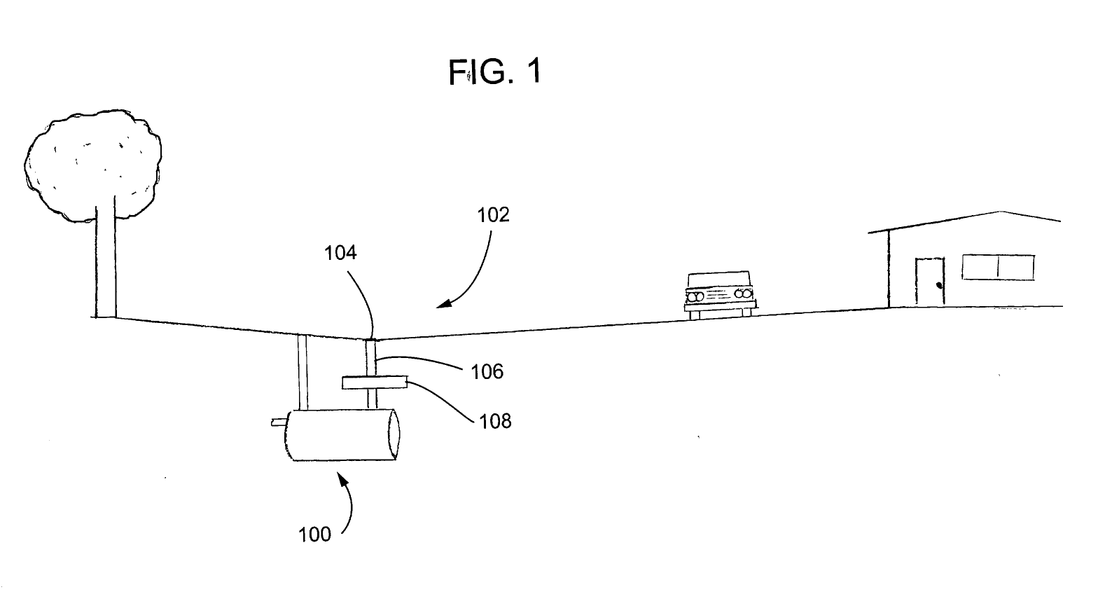

Referring now to the drawings, wherein like reference numerals refer to like elements, FIG. 1 illustrates an oil-water separator 100 in an illustrative setting such as a paved parking lot 102. Deposited on the surface of parking lot 102 may be grease and oil drippings that have leaked from parked vehicles. Parking lot 102 is graded so that its lowest point is formed at or near grate 104. Located beneath the parking lot and communicating with grate 104 is drainpipe 106 that in turn communicates with oil-water separator 100 located downstream. It should be readily apparent that rainwater falling on parking lot 102 will flow under the influence of gravity to grate 104 from where it will be channeled by drain pipe 106 to the oil-water separator. It should also be apparent that grease and oil deposits will mix with and be carried away by the rainwater to oil-water separator 100.

Advantageously, oil-water separator 100 may be located below ground or, where applicable, above ground. Furthermore, where desirable, an interceptor 108 can be provided inline with drain pipe 106 to remove large objects from the mixture that could otherwise obstruct the operation of oil-water separator 100.

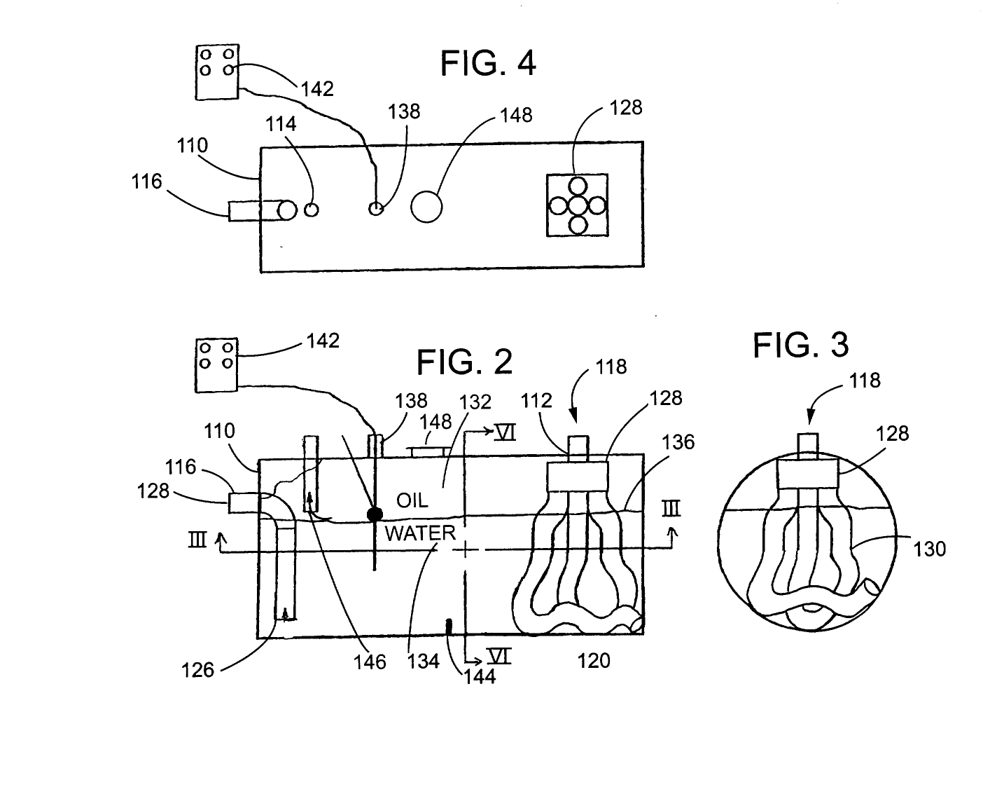

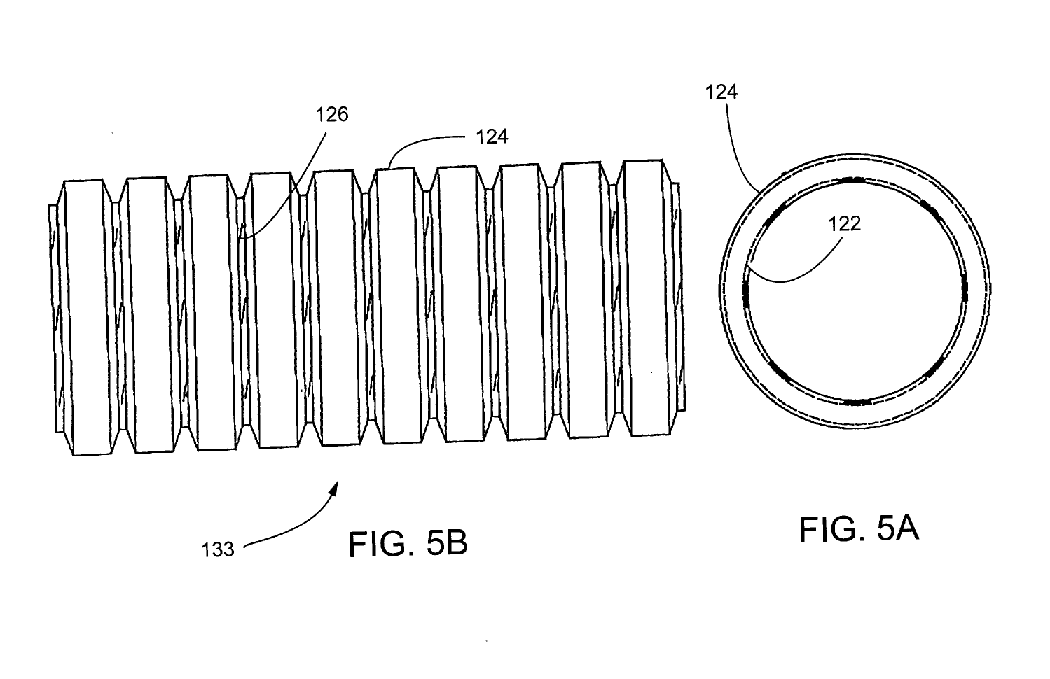

Illustrated in better detail in FIGS. 2-4 is an embodiment of oil-water separator 100. Briefly, the oil-water separator includes a tank 110 with an inlet 112, an oil pump out outlet 114, and a water outlet pipe 116, all disposed through the tank at various locations. A length of inlet pipe 118 located partially inside the enclosed volume 120 defined by the tank communicates with inlet 112. The oil-water mixture is introduced into the oil-water separator through inlet 112 thus into the inlet pipe 118. Preferably, the mixture is gravity-fed into the separator. However, the mixture may be pumped into the separator. In addition, the separator may be vented to atmosphere.

In accordance with the teachings of the present invention, there is provided an oil-water separator including a tank having an inlet and two outlets, the first outlet being disposed at a lower location within the tank than the second outlet. A mixture of oil and water is introduced to the inlet and passes through a length of coalescing pipe attached thereto. Passing the mixture through the pipe facilitates the separation of oil and water from the mixture. The separated oil and water enter an enclosed volume defined by the tank where further separation can occur. Because of its lighter specific gravity, the oil floats on top of the water while in the enclosed volume. For discharging the water while retaining the oil, the water exits through the first, lower outlet that is inaccessible to the floating oil. The retained oil can periodically be removed through the second, higher outlet.

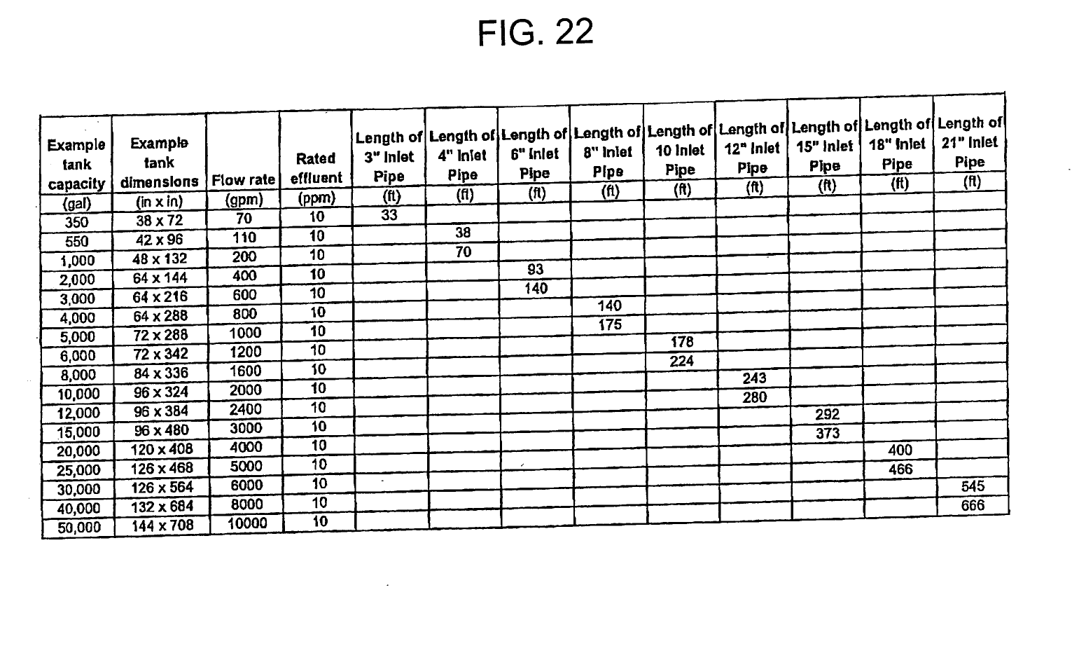

While tank 110 as shown in FIG. 2 is cylindrical, the exact shape is unimportant and other shapes are contemplated. Furthermore, the tank may be of single-walled or double-walled construction. The dimensions of tank 110 and correspondingly the capacity of the enclosed volume 120 can vary in size according to the anticipated mixture to be processed through the oil-water separator. For example, smaller tanks with a capacity of 300 gallons will suffice for facilities where the required throughput is minimal while tanks with the capacities on the order of 50,000 gallons may be necessary for larger facilities. To reduce the material costs of the oil-water separator, the specific dimensions should preferably be standardized to allow for use of existing, mass-produced tanks. Examples of tank capacity and dimensions as related to throughput are given in the chart shown in FIG. 22.

Preferably, tank 110 is constructed from steel, though other metals, plastic and other materials will adequately suffice. If the tank is located below ground and the tank is made of steel, the tank may be coated with fiberglass, urethane, or other suitable coating for an underground tank. If the tank is located above ground and the tank is made of steel, the tank may be painted. In addition, the inner surface of the tank may be coated with a rust or corrosion resistant coating. To provide access to enclosed volume for building and making repairs to the separator, a manway 148 may be disposed through the tank 110. The manway may be circular, square, or other suitable shape.

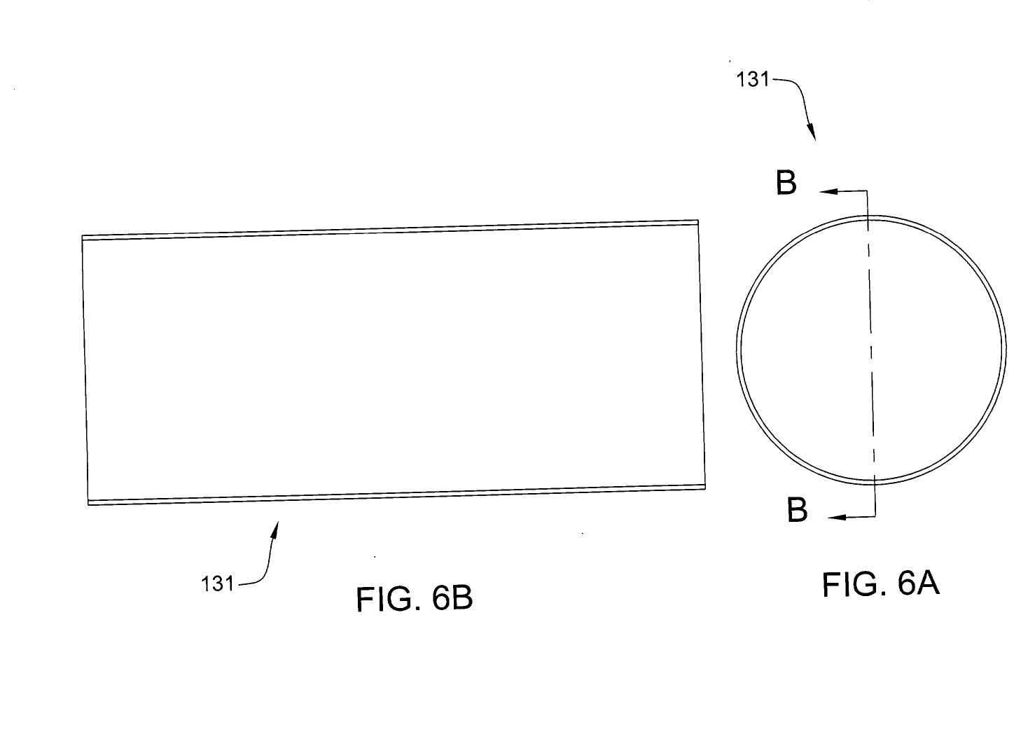

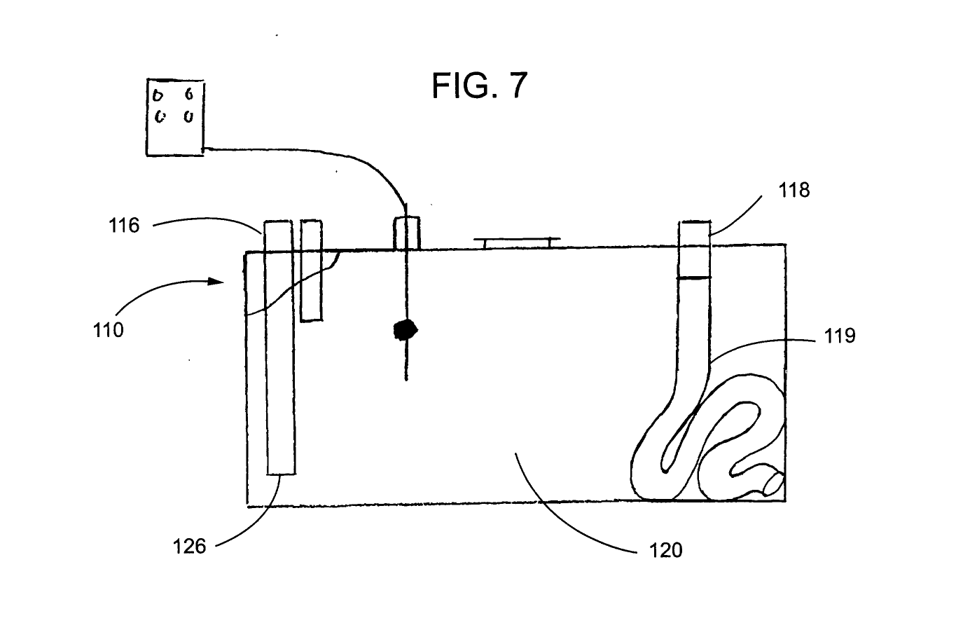

In the embodiment shown in FIGS. 2-4, inlet pipe 118 communicates with manifold box 128 which in turn communicates with a plurality of additional lengths of coalescing pipe 130. However, the manifold box may be excluded in other embodiments and inlet pipe 118, as illustrated in FIG. 7, may be connected to a single length of coalescing pipe within the enclosed volume 120. Furthermore, in the illustrated embodiment, the number of additional lengths of coalescing pipe 130 may vary and their exact diameter can vary from that of inlet pipe 118. The coalescing pipe should have sufficient surface area in order to process the oil and water mixture. The appropriate surface area can be achieved by using a combination of length, diameter and quantity for the coalescing pipe. The coalescing pipe may be corrugated with perforations or the coalescing pipe may be corrugated without perforations, such as the pipe 133 shown in FIGS. 5A and 5B. In addition, the coalescing pipe may be smooth (i.e. non-corrugated) with perforations or the coalescing pipe may be smooth without perforations, such as, the pipe 131 shown in FIGS. 6A and 6B. Preferably, the coalescing pipe should be flexible. Examples of lengths and diameters of coalescing pipe for various throughputs are given in the chart shown in FIG. 22.

In a preferred embodiment, the coalescing pipe may be a corrugated pipe. The corrugated sides of the pipe helps to slow down the velocity of the incoming mixture. A section of corrugated pipe, as is illustrated in FIGS. 5A and 5B, is formed as a circular pipe whose minimum and maximum diameter continuously alternate along its length. The pipe is hollow and therefore has a corrugated inner surface 122 and a corrugated outer surface 124. Also, in part because of the corrugations, the pipe is considerably flexible. Furthermore, the particular pipe illustrated in FIG. 5A has multiple perforations 126 spaced around its circumference that penetrate from the outer surface through to the inner surface. Pipe of this type is typically used in construction and landscaping and is therefore readily available in large quantities at low costs. Standards governing the details of this piping include ASTM F405, AASHTO M 252M, ASTM F667 and AASHTO M294M, all incorporated herein by reference.

Preferably, the pipe is made from a plastic oleophilic material such as polyethylene. Advantageously, polyethylene is relatively corrosion resistant and not susceptible to rusting. The diameter of the pipe is determined with reference to the anticipated throughput and tank capacity. For example, a 3 inch diameter pipe may be sufficient for a low throughput application while a 21 inch diameter pipe may be used with the 50,000 gallon capacity tanks. Examples of pipe diameters for particular capacities are given by the chart shown in FIG. 22.

Manifold box 128 can be constructed from steel or other appropriate material. The manifold box should adequately accommodate both inlet pipe 118 and the additional lengths of coalescing pipe 130. The actual shape of the manifold box may be rectangular, spherical, or any other shape.

In operation, for separating the oil and water, the inflowing mixture is passed through inlet pipe 118 and into manifold box 128 that distributes the mixture among coalescing pipes 130. Specifically, the pipe slows down the velocity of the incoming mixture thereby reducing turbulence which allows for the suspend oil particles to begin to coalesce together. Furthermore, due to the oleophilic nature of the pipe material, the oil tends to adhere to the corrugated sides where it continues to coalesce together. To take full advantage of this effect, the available surface area is increased by employing the manifold box and the plurality of coalescing pipes.

As the mixture enters the pipes the coalesced oil gathers together and gravitates toward the upper regions of the horizontal and vertical sections of the pipes. This occurs because the specific gravity of oil, typically on the order of 0.70 to 0.95, is less than that of water, typically 1.0, causing the oil to float on top of the water. The separated fluids inside the coalescing pipes migrate to the enclosed volume through the outlet of the pipes and through the perforations 126 to allow for additional incoming mixture to fill the pipes. In the enclosed volume, coalesced oil 132 at the top and purified water 134 at the bottom form and are separated by boundary layer 136. Furthermore, because the separated fluids are calmly maintained in the enclosed volume 120, coalescing of oil particles and their separation from water continues within the enclosed volume.

For enabling the separated water to discharge from the oil-water separator while retaining the oil, water outlet pipe 116 is disposed through the tank. As illustrated in FIG. 2, outlet pipe 116 is formed as an elbow and mounted so that opening 126 is directed toward the bottom of the enclosed volume. However, as illustrated in FIG. 7, outlet pipe 116 may be formed as a straight pipe mounted through the top of the tank 110 and having sufficient length so that opening 126 is in proximity to the bottom of the enclosed volume. Referring back to FIG. 2, as is commonly known in the art, the fluids inside enclosed volume 120 will seek to reach equilibrium with discharge end 128 of the outlet pipe. As should be apparent from FIG. 2, once equilibrium is reached between enclosed volume 120 and discharge end 128, the addition of more inflowing mixture will force water from the bottom of enclosed volume up opening 126 and through water outlet pipe 116. Because of its location at the bottom of the enclosed volume, opening 126 is inaccessible to the floating oil. To ensure that the separated oil has had an adequate chance to rise to the top of the water after discharge into the enclosed volume, the water outlet pipe 116 and the inlet 112 are preferably located on opposite sides of tank.

In some embodiments, the length of coalescing pipe is longer than the height of the enclosed volume. In these embodiments, the coalescing pipe collects at the bottom of the tank. Preferably, to avoid contaminating the exiting water, the coalescing pipe is arranged so that its outlet is directed away from water outlet pipe 116. In the embodiments utilizing the manifold, the multiple pipes may be strapped together. Furthermore, sediment washed into the separator will settle out of the mixture passing through the coalescing pipe to the bottom of the enclosed volume. To prevent the collected sludge from accessing water outlet pipe 116, a sludge baffle 144 may be installed across the bottom of the enclosed volume where it acts as a barrier. Preferably, the sludge baffle is a wall extending upwards in the enclosed volume and is located between the coalescing pipe communicating with the inlet and the water outlet pipe. The collected sludge must be periodically removed from the separator.

Preferably, to ensure proper operation, the separator is filled to the equilibrium level with water prior to startup. As should be appreciated by those of skill in the art, the equilibrium level within the enclosed volume will vary according to the location of the discharge end 128. When a mixture is not entering the inlet 112, the tank may contain a layer of air depending upon the height of the discharge end 128.

For monitoring the accumulation of oil inside the enclosed volume, an alarm system may be provided which monitors the location of boundary layer 136. As illustrated in FIGS. 2 and 3, an exemplary alarm system includes an oil level control panel 142 and an oil level float switch 138 with float 140 configured with a density between that of oil and water so that it floats upon and is raised or lowered by boundary layer 136. The construction of float switches is generally well-known in the art and need not be described in further detail here. If the maximum amount of oil accumulates in the tank, thereby lowering boundary layer 136 and float 140 past a predetermined point, the float switch 138 signals the oil level control panel 142. The oil level control panel should be appropriately located to allow for frequent monitoring. When the tank itself is in a position that permits visual monitoring, a low cost sight glass may be substituted for the float switch. In addition, the oil level may be monitored by using a stick or pole which is inserted into the oil pump out outlet 114. Importantly, oil should not be allowed to accumulate to such an amount that boundary layer 136 is lowered below opening 126.

To remove the accumulated oil 132, an outlet is disposed through the tank to access the enclosed volume. As preferably illustrated, oil pump out outlet 114 is disposed through the outlet into the enclosed volume. Oil pump out outlet 114 need only access the oil 130 in the upper regions of the enclosed volume and therefore opening 144 of the outlet is disposed above opening 126 of water outlet pipe 116. The oil pump out outlet 114 may include a pipe extending downward into the tank and may include a pipe extending upward from the tank. A pump can be attached to or inserted into the oil pump out fitting 114 and used to draw oil out for proper disposal. With above ground separators, as an alternative to pumping the oil out, a drain cock can be employed. Preferably, fresh water is added through the inlet 112 to replace the oil removed from the enclosed volume. The addition of the water helps to ensure proper start up when the oil-water separator is placed back into operation.

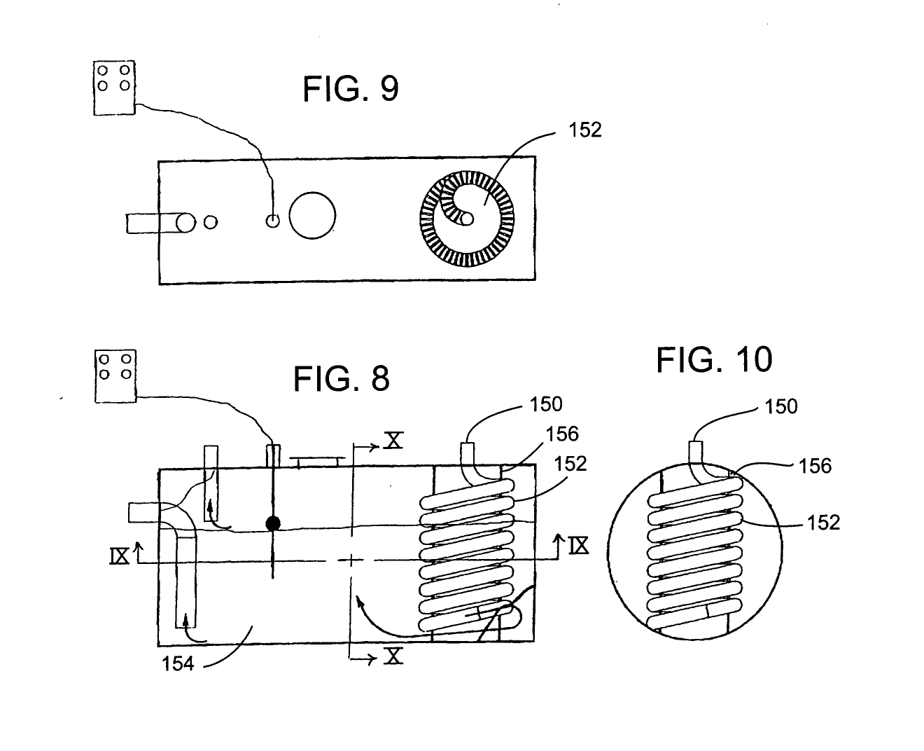

Illustrated in FIG. 8 is another embodiment of the present invention in which the coalescing pipe 150 is configured into a helix 152 within the enclosed volume 154. Advantageously, in the embodiments utilizing corrugated pipe, the inherent flexibility of the corrugate pipe facilitates its configuration into helix 152. To maintain the shape of the helix, it is preferable to attach the coils to a frame 156 situated inside the tank. Preferably, the frame 156 is manufactured from or treated with a corrosion resistant material to maintain the integrity of the frame 156 inside the tank. Nylon or plastic tie wraps can be used to fasten the coalescing pipe to frame 156.

The advantage of using the helix 152 is that it imparts a centrifugal force on the incoming mixture as it winds through the coils. The centrifugal force initially throws the mixture against the inner surface of the coalescing pipe resulting in better distribution of mixture among the sidewalls. The centrifugal force also causes the heavier water particles to separate from the lighter oil particles in the same manner as a centrifuge. As the oil coalesces together, it gathers at the sidewalls of the coalescing pipe. In the embodiments utilizing pipe with perforations, the coalesced oil can exit the pipe through the circumferential perforations 126 disposed therein as shown in FIG. 5. Returning to FIG. 8, another advantage of coiling the coalescing pipe into helix 156 is that increasingly longer coalescing pipes can be accommodated in a tank of a given capacity. The increased length results in an increase in surface area against which oil can contact and coalesce against.

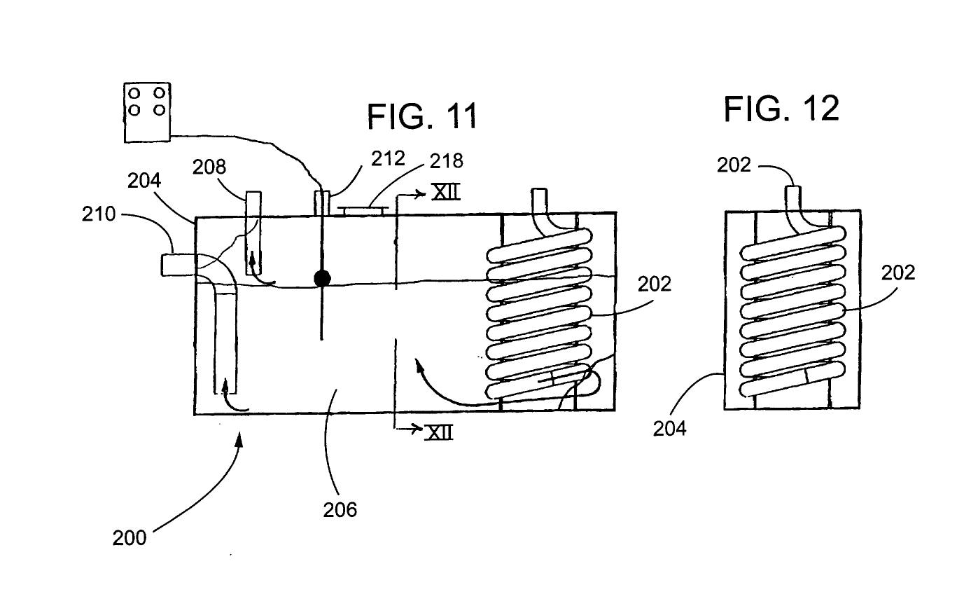

Illustrated in FIGS. 11-12 is another embodiment of the oil-water separator 200 including a helically configured coalescing pipe 202 located inside an enclosed volume 206 defined by a rectangular tank 204. However, the shape of the tank is ultimately unimportant and the rectangular shape illustrated in FIG. 12 is for illustrative purposes only. While the dimensions for tank 204 can be set at any size to accommodate the various throughput requirements, it is preferable that the exact dimensions chosen allow for use of standardized tanks to reduce the cost of the oil-water separator.

Though rectangular oil-water separator 200 is illustrated as including coiled helix 202, the use of an uncoiled single length or multiple lengths of coalescing pipe is contemplated. Oil-water separator 200 also includes such items as oil pump-out fitting 208, water outlet pipe 210, manway 218, and oil level float switch 212 so that it operates in the above-described manner.

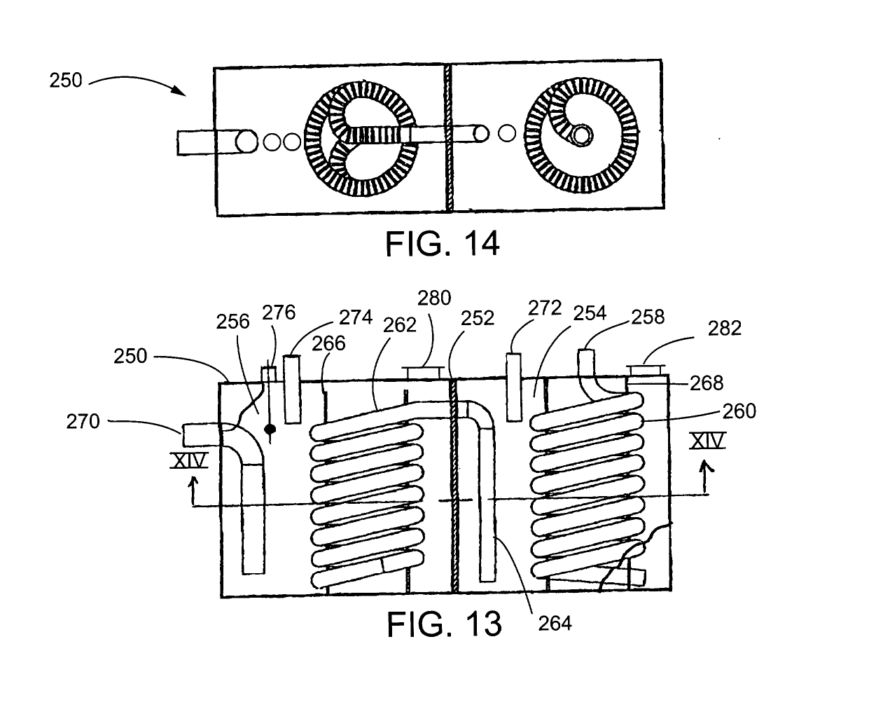

Illustrated in FIGS. 13-14 is another embodiment in which the enclosed volume defined by tank 250 is divided by a baffle 252 into a first region 254 and a second region 256. The mixture enters the oil-water separator through inlet 258 and passes through a first coalescing pipe helix 260 where an initial stage of separation occurs in the above described manner. The first helix 260 then discharges into the first region 254.

To provide a second stage of separation, a second coalescing pipe helix 262 is vertically located in the second region 256. For transfering mixture from the first region 254 to the second helix 262, a transfer pipe 264 extends from the bottom of the first region through the baffle plate 252 to the top of the second helix. Once the level of the separated fluid in the first region rises higher than the top of the second helix 262, any additional mixture flowing into the first region 254 will drive the existing fluids through the transfer pipe 264 into the second helix 262. By locating the inlet of the transfer pipe 264 near the bottom of the first region 254, the floating oil initially separated in the first helix 260 can not access the transfer pipe 264 and will not be transferred to the second helix 262.

To maintain the shapes of the two helixes, it is preferable to attach the coils to frames 266, 268 situated inside each region 254, 256. Nylon or plastic tie wraps can be used to fasten the coalescing pipe to frames 266, 268. To allow the separated water to exit the second region 256, a water outlet pipe 270 is disposed through the tank wall and operates in the above-described manner. Oil pump-out fittings 272, 274 are provided in each region near the top of the tank for removing the separated oil. For monitoring the oil level inside tank 250, an oil level float switch 276 can be provided. To provide access to each enclosed region 254, 256, separate manways 280, 282 are disposed through tank 250.

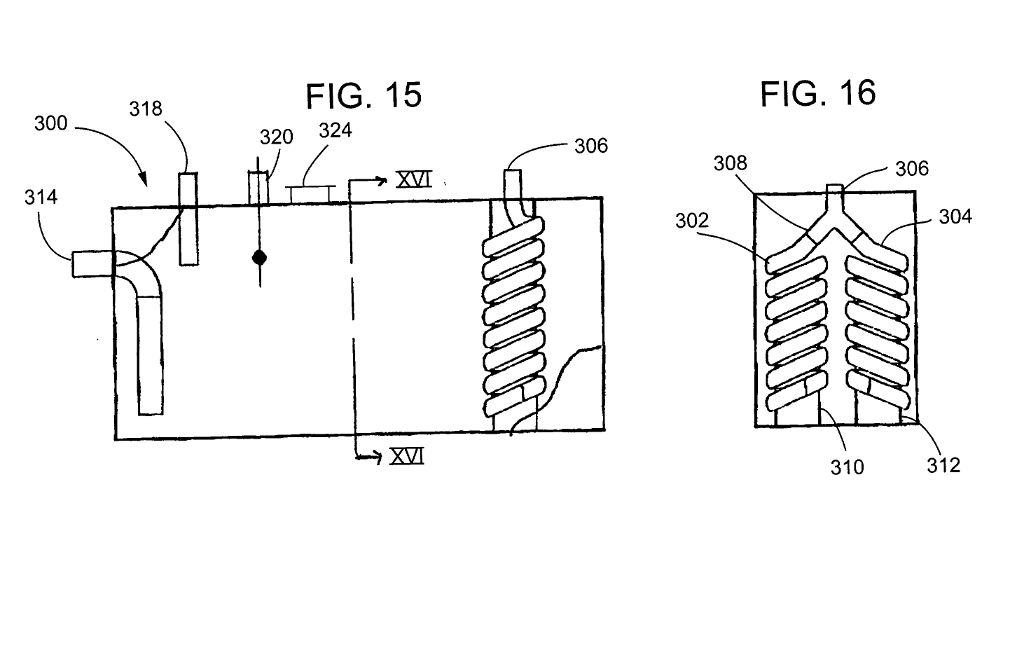

The embodiment illustrated in FIGS. 15-16 shows an oil-water separator configured to increase the surface area of the coalescing pipe for the incoming mixture to contact. As discussed above, the increase in surface area improves on the tendency of oil to coalesce together thereby improving the separation of oil and water. Specifically, to increase the available surface area, two coalescing pipe helixes 302, 304 are provided inside tank 300. To distribute the incoming mixture between the two helixes, a Y-shaped fitting 308 attached to both helixes communicates with the inlet 306. Two frames 310, 312 are provided for supporting the helixes. The oil-water separator illustrated in FIGS. 15-16 includes such items as oil pump-out fitting 318, water outlet pipe 314, manway 324, and oil level float switch 320 so that it operates in the above-described manner.

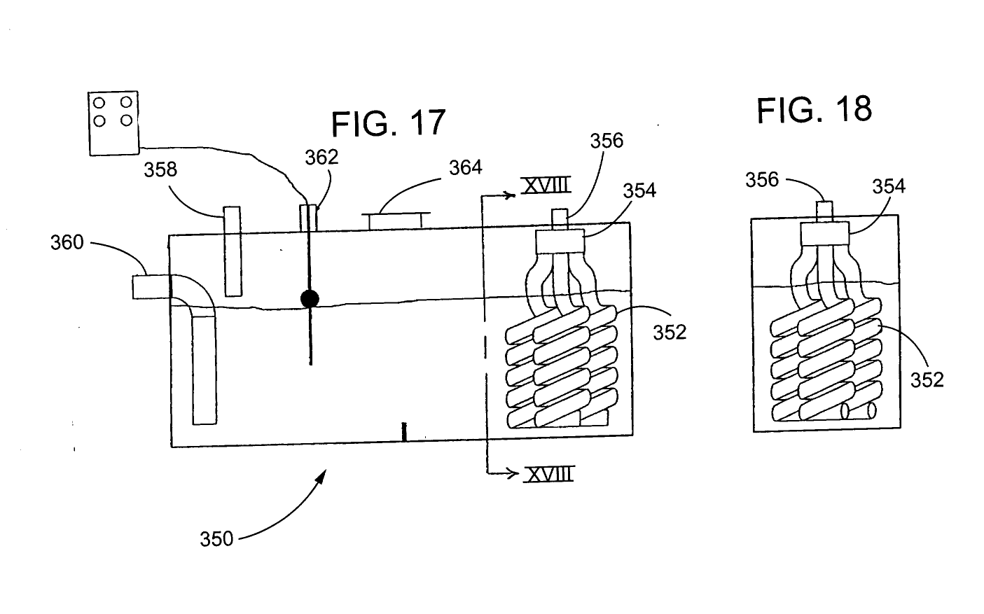

In the embodiment illustrated in FIGS. 17-18, the oil-water separator 350 is arranged to distribute the mixture among several helically configured coalescing pipes 352. To accomplish this, each helix communicates with manifold box 354 that in turn communicates with the inlet 356. This embodiment combines the advantage of imparting a centrifugal flow to the mixture with the advantage of increased sidewall area provided by using several coalescing pipes. To operate in the above-described manner, oil-water separator 350 may also include such items as oil pump-out fitting 358, water outlet pipe 360, and oil level float switch 362.

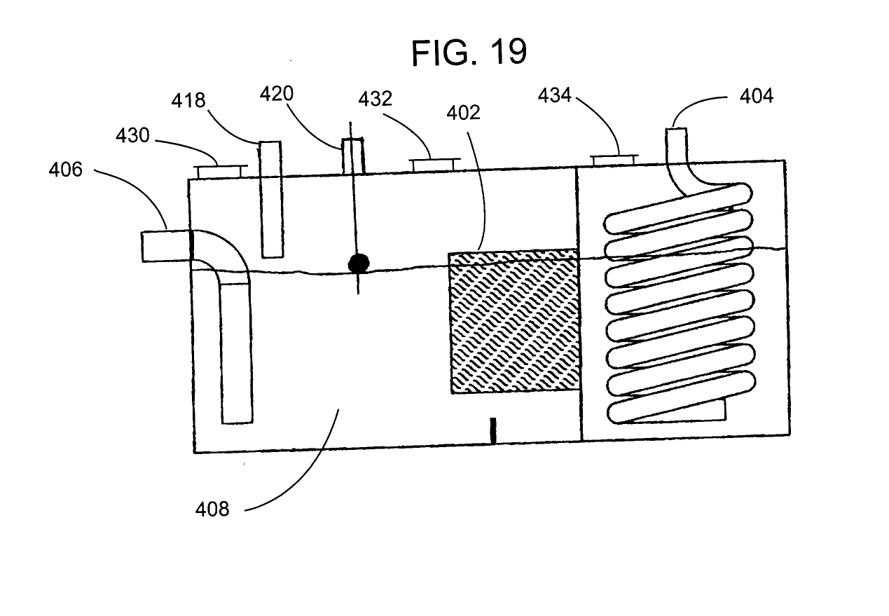

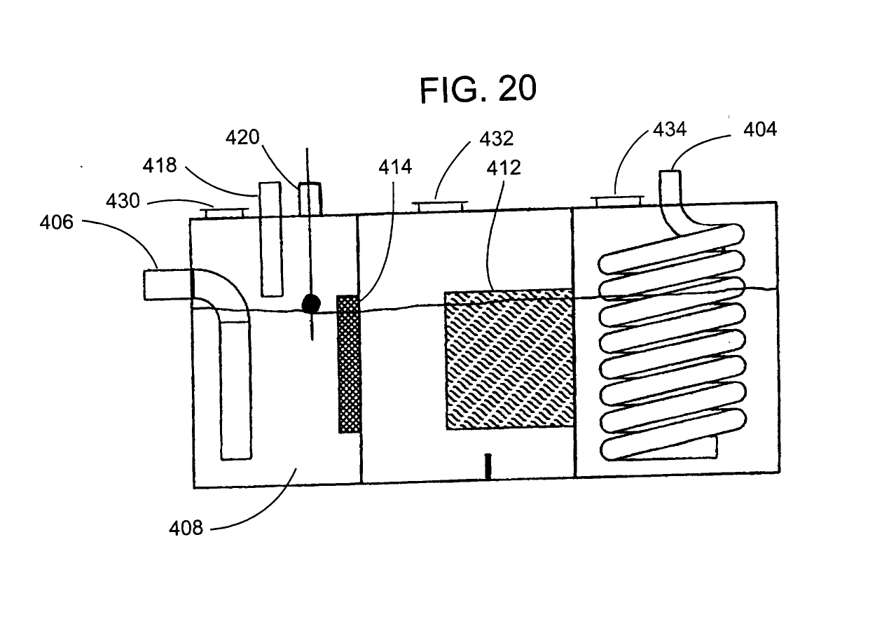

For further aiding in the separation of oil from water, in some embodiments, the oil-water separators may include additional coalescing media. Examples of such media include honeycomb plates, corrugated baffles, or mesh filters which are commonly known in the art. As illustrated in FIG. 19, the coalescing media 402 should be placed within the enclosed volume 408 between the inlet corrugated pipe 404 and the water outlet pipe 406. To retain the additional coalescing media in the correct position within the enclosed volume, coalescing media frames are provided to which the media can be attached. Care should be taken to ensure that the coalescing media does not completely obstruct fluid flow through the oil-water separator. As illustrated in FIG. 20, where the size of the tank permits, multiple coalescing media 412, 414 components can be provided inside the oil-water separator for an increased coalescing effect. While FIG. 19 and FIG. 20 are illustrated as including a single helically configured coalescing pipe, the additional coalescing media may be employed with any of the above mentioned coalescing pipe configurations. To operate in the above described, the illustrated oil-water separators may also include such items as oil pump out fitting 418 and oil level float switch 420. A plurality of manways 430, 432, and 434 are disposed through the tank to provide access to various parts of the enclosed volume.

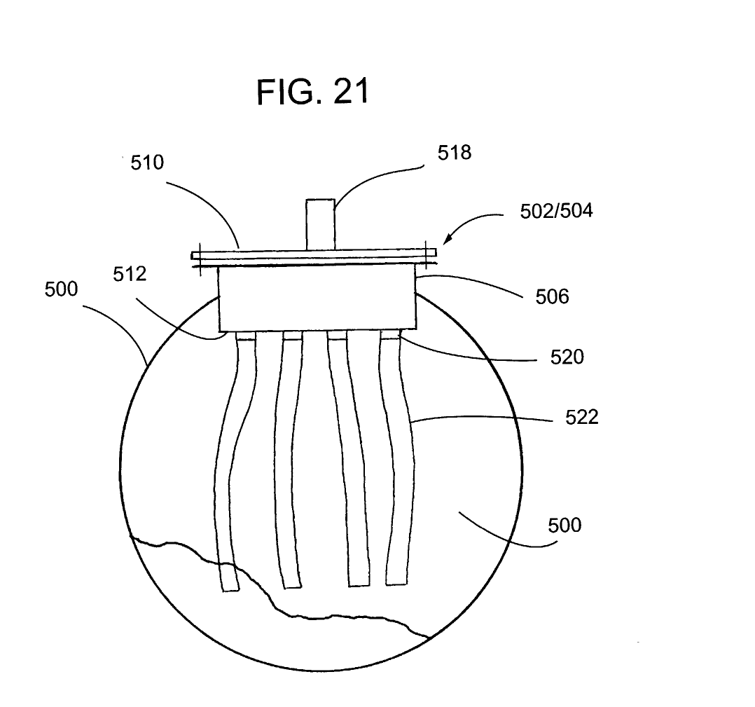

In another embodiment illustrated in FIG. 21, the manifold box 502 is combined with the manway 504 disposed through the tank 500. In particular, the manway 504 may be constructed as a sidewall 506 intersecting through the tank 500 into the enclosed volume 508. The manway further includes a cover 510 and a base 512 spaced apart from each other by the sidewall. To introduce mixture into the enclosed volume 508, there is disposed through the cover 510 an inlet pipe 518. Disposed through the base 512 is a plurality of outlets 520 and to each outlet is connected a coalescing pipe 522 that discharges into the enclosed volume 508. Mixture entering through the cover is thereby distributed among the plurality of coalescing pipes 522 through which the mixture passes. To use the manway to gain access to the internal volume, the cover 510 and base 512 may be removed.

The oil water separator may be built in accordance with UL Subject 2215 Outline of Investigation for Oil/Water Separators which is incorporated herein by reference.

Thus, the present invention provides a low-cost device and method for separating oil from water. The present oil-separator employs readily available coalescing piping to cause oil to coalesce together then advantageously utilizes the natural tendency of oil to float upon water to retain the separated oil within a tank while discharging the water.

While particular embodiments of the invention have been shown, it will be understood that the invention is not limited thereto. On the contrary, we intend to cover all alternatives, modifications, and equivalents as may be included within the scope and spirit of the invention as defined by the appended claims. Accordingly, the described locations and configurations of the corrugated pipes, inlets, outlets, alarms and baffles are to illustrate the operation of the invention and variation from the precise description is anticipated.

What is claimed is:

1. An oil-water separator comprising:
a tank defining an enclosed volume, the tank having an inlet, a outlet, and a second outlet;
a first length of coalescing pipe located in the enclosed volume and communicating with the inlet.

2. The oil-water separator of claim 1, wherein perforations are disposed through the first length of pipe.

3. The oil-water separator of claim 1, further comprising a manifold box through which the first length of pipe communicates with the inlet.

4. The oil-water separator of claim 3, wherein the first length of pipe is a plurality of lengths of pipe communicating with the inlet through the manifold box.

5. The oil-water separator of claim 4, wherein the plurality of lengths of pipe are each configured into a helix.

6. The oil-water separator of claim 1, wherein the first length of pipe is configured into a helix.

7. The oil-water separator of claim 6, wherein the helix is coiled around a frame.

8. The oil-water separator of claim 1, further comprising a second length of pipe located in the enclosed volume and a Y-pipe located in the enclosed volume, wherein the first and second lengths of pipe communicate with the inlet through the Y-pipe.

9. The oil-water separator of claim 8, wherein the first and second lengths of pipe are each configured into a helix.

10. The oil-water separator of claim 1, further comprising a baffle, a transfer pipe, and a second length of pipe, wherein
the baffle separates the enclosed volume into a first region and a second region;
the first length of pipe is located in the first region; and
the second length of pipe is located in the second region and communicates with the first region via the transfer pipe.

11. The oil-water separator of claim 10, wherein the first and second lengths of pipe are each configured into a helix.

12. The oil-water separator of claim 1, wherein the first outlet and the second outlet each include an opening within the enclosed volume;
the opening for the first outlet being located below the opening for the second outlet.

13. The oil-water separator of claim 12, wherein the first outlet includes a water outlet pipe, the water outlet pipe defining the opening.

14. The oil-water separator of claim 12, where the second outlet includes an oil pump out outlet, the oil pump out outlet defining the opening.

15. The oil-water separator of claim 1, further comprising coalescing media enclosed in the enclosed volume.

16. The oil-water separator of claim 1, further comprising an oil level alarm system for monitoring the amount of oil in the tank.

17. The oil-water separator of claim 16, wherein the oil level alarm system is a oil level float switch located in the enclosed volume that communicates with an oil level control panel located outside the enclosed volume.

18. The oil-water separator of claim 1 wherein the coalescing pipe is corrugated.

19. The oil-water separator of claim 18 wherein the coalescing pipe is perforated.

20. The oil-water separator of claim 1 wherein the coalescing pipe is smooth.

21. The oil-water separator of claim 20 wherein the coalescing pipe is perforated.

22. The oil-water separator of claim 1 wherein the coalescing pipe is flexible.

23. A method of separating oil from a oil-water mixture running off a parking lot, the method comprising
providing a tank defining an enclosed volume of a predetermined height, the tank having a inlet, a first outlet, and a second outlet located above the first outlet;
introducing the oil-water mixture to the inlet, passing the mixture through a coalescing pipe communicating with the inlet so that oil separates from the mixture and coalesces together;
transferring the separated water from the enclosed volume through the first outlet; and
retaining the separated oil in the tank by allowing the separated oil to float on top of the separated water above the second outlet.

24. The method of claim 23, further including monitoring the volume of the retained oil with an oil level float switch located in the enclosed volume.

25. The method of claim 23, further including removing the retained oil through the first outlet.

26. The method of claim 23, further including passing the oil-water mixture through a plurality of pipes each communicating with the inlet.

27. The method of claim 23, further including imparting a centrifugal force onto the oil-water mixture passing through the pipe.

28. The oil-water separator for separating out oil that is mixed with water, the oil-water separator comprising:
a tank for retaining separated oil, the tank including a surface defining an enclosed volume of a predetermined height, the tank further including an inlet, a first outlet having an opening within the tank, and a second outlet having an opening within the tank, the first outlet opening located below the second outlet opening; and
a first length of coalescing pipe being at least partially located in the enclosed volume and communicating with the inlet.

29. The oil-water separator of claim 28, further comprising a manifold box through which the first length of pipe communicates with the inlet.

30. The oil-water separator of claim 28, wherein the first length of pipe is a plurality of lengths corrugated pipes communicating with the inlet through the manifold box.

31. The oil-water separator of claim 28, wherein the first length of pipe is configured into a helix.

32. The oil-water separator of claim 28, further including an oil-level float switch located in the enclosed volume for monitoring the retained oil.
